(19) United States
(12) Patent Application Publication
(10) Pub. No.: US 2012/0041798 A1
(43) Pub. Date: Feb. 16, 2012

(54) Rough Planning System for Factories

(76) Inventor: Martin Prescher, Munchen (DE)

(21) Appl. No.: 13/259,636

(22) PCT Filed: Feb. 10, 2010
(86) PCT No.: PCT/EP10/51607

§ 371 Date: Sep. 23, 2011

(30) Foreign Application Priority Data
Mar. 24, 2009 (DE) 102009014537.0

(51) Int. Cl. G06Q 10/00

(52) U.S. Cl. 705/7.27

(57) ABSTRACT

In a method for designing a factory in particular the machinery inventory, required buildings, foundations and floor space are determined. The recognition of synergy potential between individual products and inter-factory capacity planning are to be enabled. The method has the steps of: inputting planning measurement data in a measurement data memory, linking the planning measurement data in a measurement data processing device by means of at least one algorithm for specifying factory parameters.

### CROSS-REFERENCE TO RELATED APPLICATIONS

This application is a U.S. National Stage Application of International Application No. PCT/EP2010/051607 filed Feb. 10, 2010, which designates the United States of America, and claims priority to German Application No. 10 2009 014 537.0 filed Mar. 24, 2009, the contents of which are hereby incorporated by reference in their entirety.

### TECHNICAL FIELD

The present invention relates to a method for designing a factory.

### BACKGROUND

A fundamental problem is to estimate factory parameters during a rough planning phase of a factory having little automated production. In principle said factory parameters are usually dominated by the machinery inventory used, specifically production, transportation and logistics machinery, required buildings, foundations and floor space. The rough planning phase for a factory typically includes specifying a possible production range, i.e. which parts or components will be or can be produced, drawing up layouts, and specifying the machinery inventory required for the underlying production program. Layouts are, for example, block layouts and comprise rough factory floor plans and rough production workflows. If the production range of the factory is relatively large, i.e. many products must be manufactured which are to some extent very different, but which are similar in certain aspects, and if the production workflows are automated only to a slight extent and are relatively flexible, then in order to support the planning phase a method is needed which enables even large planning teams to recognize inter-factory synergy potential among different production workflows and to realize said potential in the machine, building and logistics planning. It is also necessary to implement a global administration of changes in the planning criteria, specifically the production program and the production range, and to incorporate these in a planning process.

It is intended that maximum automation of a planning process for factories having little automated production should be provided. It is intended for global, reliable and standardized access to the planning measurement data to be possible, specifically without the risk of data duplication, data loss or inconsistency.

### SUMMARY

According to an embodiment, a method for designing a factory may comprise the steps of inputting planning measurement data into a measurement data memory and linking planning measurement data in a measurement data processing device by means of at least one algorithm for specifying factory parameters.

According to a further embodiment, planning measurement data can be technical details concerning parts to be produced or products and/or technical descriptions of production workflows. According to a further embodiment, the technical descriptions may relate to existing and future production workflows. According to a further embodiment, factory parameters can be technical specifications concerning foundations, buildings, machinery inventory and/or machinery floor space. According to a further embodiment, the method may comprise identification, by means of the algorithm, of optimization potential of individual parts to be produced or of production workflows and of the factory. According to a further embodiment, the method may comprise identification, by means of the algorithm, of synergy potential between individual parts to be produced or production workflows and, in cases where a plurality of factories are being designed, between individual factories. According to a further embodiment, the method may comprise implementation of inter-factory capacity planning by means of the algorithm in cases where a plurality of factories are being designed. According to a further embodiment, the method may comprise generation of production scenarios as a function of the planning measurement data. According to a further embodiment, the method may comprise recognition of inconsistencies that are to be expected in the planning measurement data. According to a further embodiment, the method may comprise data exchange between planning personnel. According to a further embodiment, the method may comprise intelligent checking of planning personnel. According to a further embodiment, the method may comprise central administration of the planning measurement data and the factory parameters.

According to another embodiment, a computer program product may be configured to perform a method as stated above.

According to yet another embodiment, a device for designing a factory, may comprise the steps of inputting planning measurement data into a measurement data memory by means of a user access controller; linking the planning measurement data in a measurement data processing device by means of an algorithm

$$V ( g ) = \frac{P \cdot {\sum }_{k = 1}^{K} M ( g , k ) \cdot Q ( k )}{s \cdot S \cdot WD} \qquad ( 1 )$$

for calculating capacity, where the number of machines in a particular machine group V is calculated, where the production program is the number P of desired products per year, G is the number of machine groups and g is ε {1, . . . , G}, where there are V machines in each group, i.e. V=V (g), there is a totality of different production workflows, where K denotes the number of different production workflows and k is ε {1, . . . , K}, where Q(k) is the quantity of components that are generated in a process k, where, in addition, the machine time M(g, k) is specified in hours, S is the number of work shifts per day having a duration of s in hours, and WD is the number of working days in a year.

According to a further embodiment of the device, the capacity calculation may be performed separately for each product by means of an algorithm

$$V ( g , j ) = \frac{P ( J ) \cdot {\sum }_{k ( j ) = 1}^{K ( j )} M ( g , k ( j ) ) \cdot Q ( k ( j ) )}{s \cdot S \cdot WD} \qquad ( 2 )$$

where j is an index for identifying a product, J is the number of products and production workflows are assigned to a product. According to a further embodiment of the device, the device may comprise a device for identifying optimization potential of individual parts to be produced or production workflows and of the factory by means of the algorithm. According to a further embodiment of the device, the device may comprise a device for identifying synergy potential between individual parts to be produced or production workflows and, in cases where a plurality of factories are being designed, between the individual factories, by means of the algorithm. According to a further embodiment of the device, the device may comprise a device for implementing inter-factory capacity planning in cases where a plurality of factories are being designed, by means of the algorithm. According to a further embodiment of the device, the device may comprise a device for generating production scenarios as a function of the planning measurement data. According to a further embodiment of the device, the device may comprise a device for recognizing inconsistencies that are to be expected in the planning measurement data. According to a further embodiment of the device, the device may comprise a device for data exchange between planning personnel. According to a further embodiment of the device, the device may comprise a device for intelligent checking of planning personnel. According to a further embodiment of the device, the device may comprise a device for central administration of the planning measurement data and factory parameters.

### BRIEF DESCRIPTION OF THE DRAWINGS

The present invention will now be described in greater detail with reference to an exemplary embodiment taken in conjunction with the figures, in which:

FIG. 1 shows an exemplary embodiment of a method;

FIG. 2 shows an exemplary embodiment of a device for performing a method according to various embodiments.

### DETAILED DESCRIPTION

According to various embodiments a method for planning a factory and/or production can be provided. In particular it is to be possible to produce many products in the factory, some of which may be very different, although they resemble one another in certain aspects. In particular the factory should possess a high degree of flexibility and a low level of automated production. In other words, a maximum of 50% of the production workflows should be automated. In particular it is aimed to determine the machinery inventory used, required buildings, foundations and floor spaces needed. Synergy potential existing between individual products should be identifiable and inter-factory capacity planning should be made possible. It is intended that global, reliable and standardized access to planning measurement data should be possible and that data duplication, data loss or inconsistencies should be avoided.

The machinery inventory comprises, for example, production and transportation or logistics machines.

The production program is the number of desired products per year.

Capacity planning is the planning of the utilization of a factory or a machine.

According to further embodiments, a computer program product and a device can be provided.

The basis is a measurement data memory and a measurement data processing device.

According to a first aspect, a method for designing a factory may comprise the steps of:

inputting planning measurement data into a measurement data memory;

linking planning measurement data in a measurement data processing device by means of at least one algorithm for specifying factory parameters.

According to an embodiment, planning measurement data can be technical details concerning parts to be produced or products and/or technical descriptions of production workflows.

According to a further embodiment, the technical descriptions can concern existing and future production workflows.

According to a further embodiment, factory parameters can be technical specifications concerning foundations, buildings, machinery inventory and/or machinery floor space.

According to a further embodiment, optimization potential in respect of individual parts to be produced or of production workflows and of the factory can be identified by means of the algorithm.

According to a further embodiment, synergy potential in respect of individual parts to be produced or of production workflows and, in cases where a plurality of factories are being designed, between individual factories can be identified by means of the algorithm.

According to a further embodiment, in cases where a plurality of factories are being designed, inter-factory capacity planning can be implemented by means of the algorithm.

According to a further embodiment, production scenarios can be generated as a function of the planning measurement data. In other words, the method supports planning teams during the generation of production scenarios. Planning results are recalculated dynamically as a function of critical production decisions and represented in a suitable manner. Critical production decisions are, for example, which parts are purchased, where each part is produced, which machines are used together, and the like. Results can be presented as reports or graphs.

According to a further embodiment, inconsistencies that are to be expected can be detected using the planning measurement data. In other words, the method is characterized by a high degree of flexibility, i.e. inconsistencies to be expected are recognized in the planning measurement data and are thus resolved.

According to a further embodiment, data exchange can take place between planning personnel.

According to a further embodiment, intelligent checking of planning personnel can be carried out.

According to a further embodiment, administration of the planning measurement data and factory parameters can be centralized.

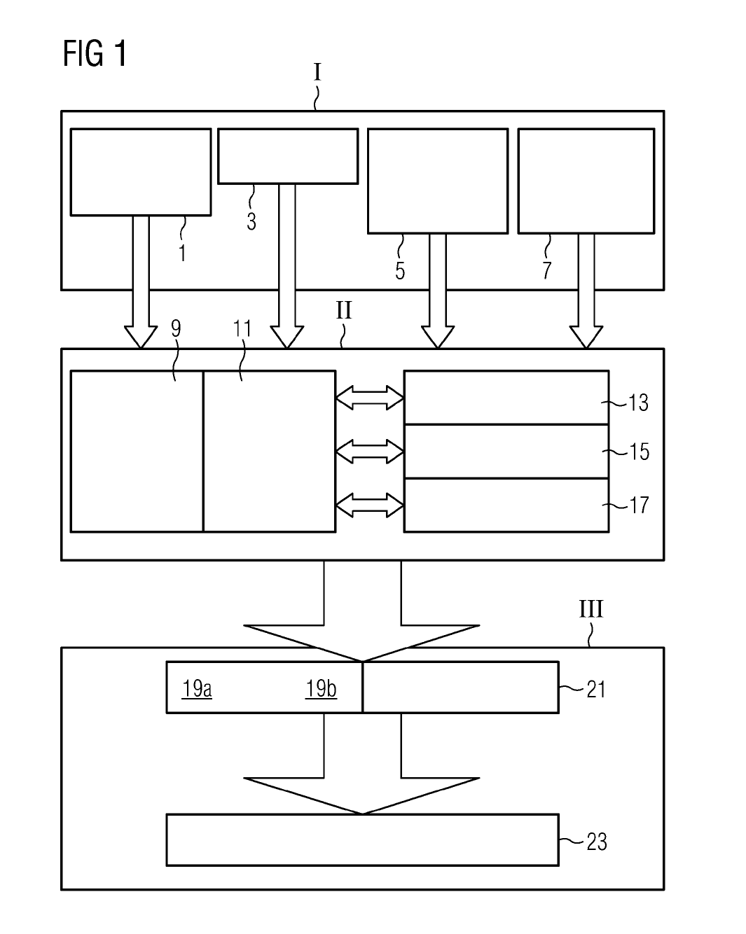

FIG. 1 shows an exemplary embodiment of a method. FIG. 1 shows an upper block of input information, a lower block of output information and a central block with processing of the database. The input block is identified by the reference sign I, the database block by the reference sign II and the output block by the reference sign III. Planning measurement data is shown in the input block I. Reference sign 1 denotes technical details of parts or products to be manufactured. This block 1 comprises components, quantities, dimensions and weights. Further details are also possible. Block 3 denotes the production program. Block 5 denotes technical descriptions of already existing production workflows. Block 7 denotes technical descriptions of future idealized production workflows. Details of the technical descriptions of production workflows can consist of specifications of machines, methods, times, logistics information and the like. Block II identifies the processing of the underlying database. Reference sign 9 denotes a product and a production program. Reference sign 11 denotes production workflows. A data exchange takes place with regard to machines 13, logistics 15 and buildings 17. The database II is converted into output variables by means of algorithms.

Output variables are synergy potentials 19a and production scenarios 19b. Further output variables are technical details concerning foundations, buildings, machinery inventory and/or machine floor spaces 21. These details also include logistics information. Capacity planning is a further aspect of block 21. Information in the blocks 19 and 21 is converted into further output variables by means of further algorithms. In this manner it is possible to define an ideal production process or production workflow. This ideal production workflow is represented by block 23.

Examples of algorithms are also described.

A capacity calculation is performed in that the number of machines in a particular machine group V is calculated. This is achieved using the following equation:

$$V ( g ) = \frac{P \cdot {\sum }_{k = 1}^{K} M ( g , k ) \cdot Q ( k )}{s \cdot S \cdot WD} \qquad ( 1 )$$

In this case the production program is the number P of desired products per year. G is the number of machine groups and g is ε {1, . . . , G}. There are V machines in each group, i.e. V=V (g). There is a totality of different production workflows, where K denotes the number of different production workflows and k is ε {1, . . . , K}. Q(k) is the quantity of components generated in a process k. Furthermore, the machine time M(g, k) is given in hours. S is the number of work shifts per day having a duration of s in hours. WD is the number of working days in a year.

The following procedure is used for so-called production or purchase decisions. If it is decided to purchase a component rather than manufacture it inhouse, the machine times M(g, k) for all the method steps necessary for the production of this component are set to zero.

Example of algorithm to determine synergy potentials.

It is assumed that a capacity calculation is performed, not for the whole factory, but for each product separately. In other words, V(g)=V(g, j), where j is an index for identifying a product. For example, if j=1, the product is a gas turbine. A number J of products is assumed. Production workflows are now assigned to a product, i.e. k=k(J). A product-specific capacity calculation is performed using the following formula:

$$V ( g , j ) = \frac{P ( J ) \cdot {\sum }_{k ( j ) = 1}^{K ( j )} M ( g , k ( j ) ) \cdot Q ( k ( j ) )}{s \cdot S \cdot WD} \qquad ( 2 )$$

Parts specifications are given in meters for length, width and height, and in kilograms for weight. Each production workflow has a part which is processed in the production workflow. For example, a length (k) is the length of a part that is produced in the process k. The same applies to width, weight and the like. Each reference machine has a list of specifications including part size that can be processed. The specifications for the machines or machine groups also have information such as the section in which the machine will be positioned. These are details relating to the location in the factory or details concerning in which of the several production locations the machine is situated. Other particular specifications can also be given, for example, “this machine should be positioned where there is access to a particular pipeline system or to particular drain outlets”. These specifications are input into the system in a standardized manner. The set of specifications of a machine group for a product is identified overall as SPEC(g,j).

The following two basic algorithms are suitable:

Basic inter-group synergy algorithm:

| | |
|---|---|
| (3) | x:=0,2 |
| | M:={ }; |
| | for j=1 to J |
| | for g=1 to G |
| | if [V(g,j)]−V(g,j)>x |
| | M:=M ∪ g(j) |
| | End for |
| | End for |
| | for all pairs (g(i),g(j)) in M |
| | if H (SPEC(g,i), SPEC(g,j)) >0 |
| | g(i)=g(j) ∪ g(j) |
| | J=J−1 |

H is a function that determines whether two sets of specifications cooperatively interact. How H weights particular parameters is dependent on the application: H provides a route for finding optimum synergies as a function of the particular application and project-specific framework conditions. The output is then positive and the degree of concordance can be measured by the resulting number. If no numerical value can be calculated, specifically because the specifications are too “soft”, the result is +1 or −1.

In a next step, intermediate production workflow synergies are determined:

| | |
|---|---|
| (4) | for k=1 to K(1)+ . . . +K(J) |
| | for j=1 to J |
| | if Z(g(j),k)>0 |
| | assign g(j) to the process |
| | store configuration |
| | run basic inter-group synergy algorithm |
| | recalculate machine and building |
| | store the result |
| | End for |
| | End for |

### Selection of Configuration with Minimum Overhead

Z is a function that determines whether a particular production workflow can also be performed by another machine group. For this purpose, by means of the function Z, the specification of a production workflow or of a part to be produced is compared with the specifications of a machine group. The result is a numerical value because the values used, such as length, width, etc., are metric values. The function assignment g(j) to the production workflow changes the machine group to which a production workflow is assigned to another value.

The function “memory configuration” stores the new product, process and machine data in a separate database so as to ensure that all the changes can be traced back and compared. In the next step, the basic inter-group synergy algorithm is applied using the new database.

### Available Machines

As already stated above, it is possible that certain machines are already present. It is assumed there is a list of machines present (k=1 to K) with specifications for new machines including cost (in this case, the cost for transporting the machine). It is very important to plan the new factory so that as few machines as possible need to be transported, since this reduces the cost. The following algorithm finds an optimum configuration of the new factory with respect to cost:

```
For all available machines k
    For j=1 to J
      For g=1 to G
        If F(SPEZ(k), SPEZ(g,j)) >0
          E(k,g) = F(SPEZ(k), SPEZ(g,j))
      End for
    End for
    gMAX = max(E(k,*))
  replace a machine in group gMAX with machine k
End for
Recalculate machine and building costs
```

The function F is fundamentally the same as the above function H. However, for particular applications, F can deviate from H in the manner in which particular specifications are weighted. For example, F would place the emphasis on the department (a machine that is present would definitely have to be in the same department). H places greater emphasis on the dimensioning of component parts. If, for example, departments of available machines and a particular group do not match one another, F would probably jump back to −1 in order to show that this machine cannot be integrated into this particular group. The same arises if part dimensions do not match. However, if departments and dimensioning do match, F jumps to a positive value and the size of this value is dependent on “softer” criteria which indicate whether the machine would fit into the group (such as water connections, power supply connections, etc.). However, the principle applies that F provides a way to find an optimum distribution of available machines into the machine groups, dependent on the project-specific use and framework conditions.

### Purchasing Times and Ordering Management

If a list of machines to be bought or to be transported has been drawn up, the purchasing times and the machine suppliers, which are part of the specifications of each machine, can be used to generate an ordering management list and to order machines and equipment automatically so as to comply with the required production schedule (the production schedule specifies when the production of which product is to commence). These steps can be performed separately for each component so that, for example, not all the machines have to be ordered at once.

Using the above algorithms, changes in the production workflow or to product specifications or to the production program lead to new production scenarios.

Scenario parameters can be defined for each production scenario. In this way various scenarios can be compared. One possible scenario parameter, for example, is productivity. In this way a method according to various embodiments can be continued such that business management-relevant variables are acquired and calculated in addition. For example, productivity can be determined using the following formula:

$$Prod = \frac{P}{TIC} or Prod \frac{P}{{\sum }_{g = 1}^{G} V ( g )} \qquad ( 5 )$$

For optional business management-relevant continuation of a method according to various embodiments, the following variables are introduced:

Machine costs C(g) as the costs of a reference machine for a machine group in euros. Retrofitting costs RC(i) are costs for modernizing an existing machine i. Usually, retrofitting costs RC<machine costs C(g). A purchase time T(g) for the reference machine in a particular machine group g is specified in months. The overall investment costs IC(g) for a machine group are calculated using the following formula:

$$IC ( g ) = C ( g ) \cdot V ( g ) = C ( g ) \cdot \frac{P}{s \cdot S \cdot WD} \cdot {\sum }_{k = 1}^{K} M ( g , k ) \cdot Q ( k ) \qquad ( 6 )$$

This formula only applies if all the machines within the machine group are not present and have to be purchased. There are w(g) machines in a group that are already present and indexed with 1. Then the formula changes to become

$$IC ( g ) = ( V ) ( g ) - w ( g ) ) \cdot C ( g ) + {\sum }_{i = 1}^{w ( g )} RC ( i ) \qquad ( 7 )$$

The total investment costs over all groups are:

$$\begin{matrix}TIC = {\sum }_{g = 1}^{G} [ ( V ( g ) - w ( g ) ) + {\sum }_{i = 1}^{w ( g )} RC ( i ) ] \\ = {\sum }_{g = 1}^{G} ( \frac{P \cdot {\sum }_{k = 1}^{K} M ( g , k ) \cdot Q ( k )}{s \cdot S \cdot WD} - w ( g ) ) \cdot C ( g ) + {\sum }_{i = 1}^{w ( g )} RC ( i )\end{matrix} \qquad ( 8 )$$

Logistics equipment is evaluated in the same way. The formulae change only slightly.

A further evaluation can be carried out for investment in buildings.

F(g) is defined as the foundation cost per m² for a particular machine group. Conventionally f is calculated by means of the following formula:

f(g)=F·t(g) (9)

where F is a basic price for a square meter and t(g) is a multiplication factor for each machine group. For example, 1 stands for a light foundation, 2 for a medium-weight foundation, . . . and 10 stands for a very heavy foundation.

The floor area (footprint) of the reference machine is also identified for each group by FP(g). Additionally required areas for a particular production workflow are identified by A(k).

Based on the capacity calculation, the overall building costs can be calculated using the following formula:

$$TBC = {\sum }_{g = 1}^{G} V ( g ) \cdot FP ( g ) \cdot f ( g ) + {\sum }_{k = 1}^{K} A ( k ) \cdot f ( k ) \qquad ( 10 )$$

In this way it is possible to perform a business management-relevant assessment of the production scenarios.

A method according to various embodiments can also be performed without any business management-relevant assessment. A business management-relevant assessment is purely optional and not mandatory. A business management-relevant assessment can therefore be performed in addition.

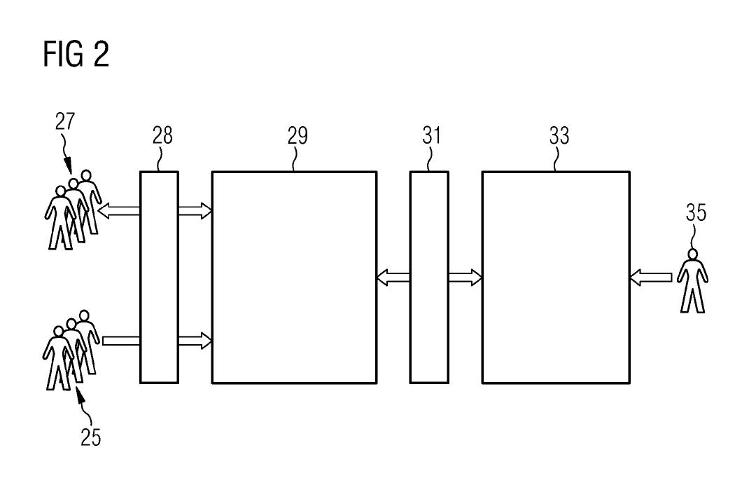

FIG. 2 shows an exemplary embodiment of a device for performing a method. Data is input by data input specialists 25 via a user access controller and an exchange of information takes place between the device and analysts 27. The information exchange is effected via a workstation. Production scenarios are generated and elaborated and data is displayed. A further function is the input and amendment of data. The workstation is identified by the reference sign 29. A user access controller is identified by reference sign 28. Data is exchanged between the workstation 29 and a server 33 via an internet connection 31. All of the planning measurement data can be stored in the server 33. Planning measurement data includes details concerning existing and ideal production workflows and the like. The server 33 is operated by a system administrator 35.

What is claimed is:

1. A method for designing a factory, comprising the steps of inputting planning measurement data into a measurement data memory; linking planning measurement data in a measurement data processing device by means of at least one algorithm for specifying factory parameters.

2. The method according to claim 1, wherein planning measurement data are technical details concerning at least one of parts to be produced or products and technical descriptions of production workflows.

3. The method according to claim 2, wherein the technical descriptions relate to existing and future production workflows.

4. The method according to claim 1, wherein factory parameters are technical specifications concerning at least one of foundations, buildings, machinery inventory and machinery floor space.

5. The method according to claim 1, wherein identification, by means of the algorithm, of optimization potential of individual parts to be produced or of production workflows and of the factory.

6. The method according to claim 1, comprising identification, by means of the algorithm, of synergy potential between individual parts to be produced or production workflows and, in cases where a plurality of factories are being designed, between individual factories.

7. The method according to claim 1, comprising implementation of inter-factory capacity planning by means of the algorithm in cases where a plurality of factories are being designed.

8. The method according to claim 1, comprising generation of production scenarios as a function of the planning measurement data.

9. The method according to claim 1, comprising recognition of inconsistencies that are to be expected in the planning measurement data.

10. The method according to claim 1, comprising
data exchange between planning personnel.

11. The method according to claim 1, comprising
intelligent checking of planning personnel.

12. The method according to claim 1, comprising
central administration of the planning measurement data and the factory parameters.

13. A computer program product comprising a computer readable medium storing instructions which when executed on a computer perform the steps of:
inputting planning measurement data into a measurement data memory;
linking planning measurement data in a measurement data processing device by means of at least one algorithm for specifying factory parameters.

14. A device for designing a factory, wherein the device is configured to:
input planning measurement data into a measurement data memory by means of a user access controller;
link the planning measurement data in a measurement data processing device by means of an algorithm
$$V ( g ) = \frac{P \cdot {\sum }_{k = 1}^{K} M ( g , k ) \cdot Q ( k )}{s \cdot S \cdot WD} \qquad ( 1 )$$
for calculating capacity, where the number of machines in a particular machine group V is calculated, where the production program is the number P of desired products per year, G is the number of machine groups and g is ε {1, . . . , G}, where there are V machines in each group, i.e. V=V (g), there is a totality of different production workflows, where K denotes the number of different production workflows and k is ε {1, . . . , K}, where Q(k) is the quantity of components that are generated in a process k, where, in addition, the machine time M(g, k) is specified in hours, S is the number of work shifts per day having a duration of s in hours, and WD is the number of working days in a year.

15. The device according to claim 14, wherein
the capacity calculation is performed separately for each product by means of an algorithm
$$V ( g , j ) = \frac{P ( J ) \cdot {\sum }_{k ( j ) = 1}^{K ( j )} M ( g , k ( j ) ) \cdot Q ( k ( j ) )}{s \cdot S \cdot WD} \qquad ( 2 )$$
where j is an index for identifying a product, J is the number of products and production workflows are assigned to a product.

16. The device according to claim 14, comprising a device for identifying optimization potential of individual parts to be produced or production workflows and of the factory by means of the algorithm.

17. The device according to claim 14, comprising a device for identifying synergy potential between individual parts to be produced or production workflows and, in cases where a plurality of factories are being designed, between the individual factories, by means of the algorithm.

18. The device according to claim 14, comprising a device for implementing inter-factory capacity planning in cases where a plurality of factories are being designed, by means of the algorithm.

19. The device according to claim 14, comprising a device for generating production scenarios as a function of the planning measurement data.

20. The device according to claim 14, comprising a device for recognizing inconsistencies that are to be expected in the planning measurement data.

21. The device according to claim 14, comprising a device for data exchange between planning personnel.

22. The device according to claim 14, comprising a device for intelligent checking of planning personnel.

23. The device according to claim 14, comprising a device for central administration of the planning measurement data and factory parameters.
